(19) United States
(12) Patent Application Publication
(10) Pub. No.: US 2011/0314891 A1
(43) Pub. Date: Dec. 29, 2011

(54) ROBOT FOR THE ELABORATION OF LINGUAL ARCHWIRES

(76) Inventor: Alfredo Gilbert, Colonia Roma (MX)

(21) Appl. No.: 13/168,327

(22) Filed: Jun. 24, 2011

Related U.S. Application Data
(60) Provisional application No. 61/484,808, filed on May 11, 2011.

(30) Foreign Application Priority Data
Jun. 28, 2010 (MX) 2010000272

(51) Int. Cl. A61C 7/00; B21F 1/00

(52) U.S. Cl. 72/372; 72/441

(57) ABSTRACT

A robot for the shaping of lingual archwires, including an anterior plate arced according to an anterior portion of a patient's teeth, wherein the anterior plate is capable of accepting an anterior portion of a lingual wire; a plurality of movable posterior bending units positioned posterior to the anterior plate, each bending unit capable of accepting a posterior portion of the lingual wire; a plurality of motors capable of selectively actuating each of the posterior bending units independently along at least one axis to bend the lingual wire along the at least one axis at a plurality of positions; a mother board in electrical communication with the plurality of motors and capable of receiving and executing instructions for desired dimensions of a lingual archwire; and a power source.

### CROSS REFERENCE TO RELATED APPLICATIONS

This invention claims benefit of priority to U.S. Patent Application Ser. No. 61/484,808, filed on May 11, 2011; and Mexico Patent Application Serial No. MX/u/2010/000272 also known as MX/E/2010/040782 filed Jun. 28, 2010.

### TECHNICAL FIELD

The invention relates to the filed of orthodontics and more specifically to a polyarticulated robotic system for the production of lingual archwires through the use of an anterior plate and controlled movement of a plurality of posterior bending units.

### BACKGROUND OF THE INVENTION

Orthodontics is the branch of dentistry concerned with the prevention, interception and correction of malocclusions and dental displacements. Orthodontics aims to ensure correct relations between the teeth, the maxilla and the mandible, as well as overall facial harmony. Orthodontic treatment is a solution for those who are concerned about the health and appearance of their teeth. However, some feel uncomfortable with the idea of wearing unsightly devices, such as traditional braces, which immediately stand out as soon as the patient talks or smiles, for the duration of the treatment. Lingual or “hidden” orthodontics was invented for precisely such people.

The term lingual orthodontics refers to those orthodontic treatments which rely on the bonding of dental structures to the lingual/palatine surface of the teeth. That is, whereas traditional braces are secured to the vestibular or outer surface of the teeth, lingual braces and structures are secured to the lingual or inner surface of the teeth. Lingual orthodontic treatments are appropriate for those who have good periodontal health and oral hygiene, and fully-developed roots.

There are a variety of advantages of lingual orthodontics compared to approaches directed towards treatments involving the vestibular surface of the teeth. Among the benefits are as follows. First, the lingual surface itself is harder and more resistant than the vestibular surface, therefore bonding dental structures to the former results in fewer instances of decalcification and caries or tooth decay. In lingual orthodontics, force is applied in the linguo-vestibular direction and thus lingual orthodontics allows the orthodontist to carry out less aggressive dental arch expansion. Some patients present wearing or deterioration of the vestibular surface of the teeth and thus further manipulation of the vestibular surface can accelerate deterioration. Lingual orthodontics facilitates proclination of the anterior teeth, and thus helps to protect the tongue during retraction of these teeth. Further, lingual orthodontics is particularly appropriate for single-arch or simple cases and can be the best option for those who do not desire to reveal the fact that they are undergoing orthodontic treatment.

Precisely made archwires are crucial to the success of lingual orthodontic treatments. However proper formation of lingual archwires is complicated by the often irregular shapes found between patients and the high level of precision required. For instance, lingual archwires require offsets which may, depending on the case, be considerable in number and/or asymmetry. Further, bending archwires for crowded cases is often extremely difficult due to the small interbracket distances and the mesiodistal width differences. Inaccuracies in the design or manufacture of the archwire can have undesirable clinical consequences. Thus there is a need for the orthodontist to have strict control over the size and shape of the archwire.

Typically, lingual archwires are shaped manually with the help of a plaster model of the patient's teeth. The procedure requires a long appointment because the orthodontist must wait for the plaster to set. An alternative to the formation of a plaster model is to upload a digital photograph of the dental arch into a computer loaded with software and design a virtual lingual archwire. This is the technical approach taken by the computer program LAMDA, the Lingual Archwire Manufacturing and Design Aid (Smile Center Dental Specialties, Mexico City, Mexico). Using LAMBDA the orthodontist is presented with a view of the dental arch on a computer screen, and designs a virtual lingual archwire as a series of straight lines to fit the screen image of the dental arch. The software, in this case LAMDA, then calculates the lengths of each of the straight lines and also the angles between each pair of neighboring sections. To calculate these lengths and angles the program assigns a pair of Cartesian coordinates (x,y) to each point of the image. The length of the straight line between any two points is then calculated using the Cartesian version of Pythagoras' Theorem. For instance, if the points 1 and 2 have the coordinates (x₁,y₁) and (x₂,y₂) respectively, the length of the straight line between them is: l=√((x₂−x₁)²+(y₂−y₁)²).

Internally LAMDA uses pixels as a unit of measurement, that is, the coordinates of each point are given in terms of the number of pixels from the origin, and lengths are consequently calculated in pixels. To convert lengths in pixels to actual lengths, such as centimeters, it is necessary to provide the program with a conversion to convert pixels to centimeters. This calibration is obtained by marking two points, one centimeter apart, on the model or on the dental mirror, and including these two points in the digital photograph uploaded to LAMDA.

The output of LAMBDA is a set of instructions describing how to manufacture the archwire designed on the screen. For example, the orthodontist could take a straight section of orthodontic wire, bend an angle of 34° at a distance of 14 mm from one end, bend an angle of 47° in the opposite direction at a distance of 3 mm from the first bend, and so on. In this way the orthodontist may manually manufacture the archwire designed with the help of LAMDA. Thus, while LAMBA provides information regarding the relationship between neighboring teeth the user is still required to bend the archwire. However, the skilled artisan will appreciate that it is extremely difficult to manually bend an archwire to the same accuracy as that provided by the computer program. Further, bending an archwire according to a set of directions can lead to variations in measurements and thus mistakes.

Another option is to buy preformed lingual archwires. That is, once the intended arch is known, the orthodontist can order a preformed archwire from a supplier already having the compensation bends included. However, the usefulness of this option is limited by the fact that the sizes and shapes of the models available are only appropriate for a limited number of cases. That is, while LAMBDA can assist the orthodontist is identifying the correct configuration of a lingual archwire, the patient remains limited as to the availability of the nearest sizing commercially available.

Therefore there remains a need to develop systems and methods that can receive information from computer software corresponding to a desired lingual archwire and to form a lingual archwire having the desired shape.

### SUMMARY OF THE INVENTION

The present invention addresses the need to provide systems and methods for the formation of a lingual archwire and provides related benefits. This is accomplished through the generation of a polyarticulated robotic, which is capable of receiving information corresponding to the desired shape of a lingual archwire and the ability to form the desired lingual archwire by actuating a plurality of bending units.

More specifically, the object above is accomplished using an apparatus, such as a polyarticulated robot, for the shaping of lingual archwires. The robot includes an anterior plate arced according to an anterior portion of a patient's teeth, wherein the anterior plate is capable of accepting an anterior portion of a lingual wire; a plurality of movable posterior bending units positioned posterior to the anterior plate, each bending unit capable of accepting a posterior portion of the lingual wire; a plurality of motors capable of selectively actuating each of the posterior bending units independently along at least one axis to bend the lingual wire along the at least one axis at a plurality of positions; a mother board in electrical communication with the plurality of motors and capable of receiving and executing instructions for desired dimensions of a lingual archwire; and a power source.

The anterior plate is generally arced complementary to a patient's incisor region and can include at least two halves movably or adjustably mounted to alter an arc of an anterior portion of a lingual wire. To accommodate or receive the lingual wire, the anterior plate may be slotted.

Each of the plurality of posterior bending units may be selectively actuated along at least two axes. In some embodiments, the posterior bending units are selectively actuated across three dimensions. In some embodiments the bending units rotate. Posterior bending units may accept the posterior portion of the lingual wire in slots or throughbores that traverse the units. Lingual wires may be further held within the slots or throughbores by clamping the lingual wire.

The robot forms the lingual archwire according to a set of instructions, which may be a set of Cartesian coordinates, angles and lengths or the like. Instructions may be manually inputted, such as through a keyboard or may be received directly from a computer loaded with suitable software, which may generate the data needed for the instructions.

The robot may be provided as part of a system for shaping a lingual archwire, which in addition to the robot includes a computer operably connected to the robot, wherein the computer includes software for generating and transferring Cartesian coordinates or information to the robot for a desired bending of a lingual archwire.

The invention also provides a method of shaping a lingual archwire using the robot, which includes connecting the robot to a computer loaded with software capable of communicating Cartesian coordinates or information corresponding to a shaped lingual archwire; and transmitting the Cartesian coordinates or information to the robot. The robot is instructed to shape the lingual archwire according to the Cartesian coordinates or information.

### DESCRIPTION OF THE DRAWINGS

FIG. 1 depicts an exemplary robot 10 according to the invention for the elaboration of lingual archwires;

FIG. 2 is an enlarged view of FIG. 1.

FIG. 3 is an exemplary configuration of motors 16a-d within the housing.

FIG. 4 is an exemplary motherboard 18 within the housing.

FIG. 5 is rear left view of the robot 10 in FIG. 1.

FIG. 6 is a rear elevational view of the robot 10 in FIG. 1.

FIG. 7 depicts the robot 10 connected to a computer 24 in an orthodontist's office.

### DETAILED DESCRIPTION

To assist the skilled artisan the following terms are provided in more detail.

The term “lingual wire” as used herein refers to orthodontic dental wire used in the construction of lingual braces. Relatedly, the term “lingual archwire” as used herein refers to orthodontic dental wire, which is shaped to a desired arc for use as a lingual brace.

The term “anterior” as used herein refers to the front and when used in connection with dental positioning corresponds generally to the region of the teeth or mouth nearest the incisors. In contrast, the term “posterior” as used herein refers to the back and when used in connection with dental positioning corresponds generally to the region of the teeth or mouth nearest the molars.

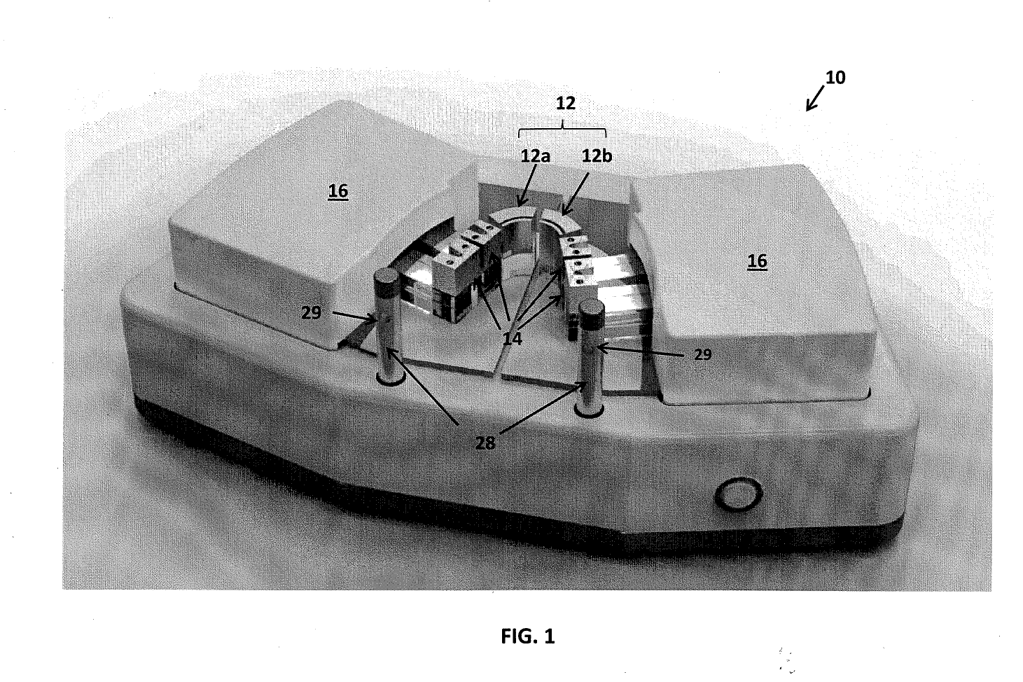

Turning to FIG. 1, a robot 10 is provided which is capable of forming a lingual archwire from a lingual wire. That is, the robot 10 is able to shape a lingual wire for use as a lingual archwire or lingual brace. The robot 10 is polyarticulated and thus is fixed in place but moves throughout a work space defined by a system of coordinates. Shaping a lingual archwire is accomplished in part through the use of an anterior plate 12 which receives or accepts an anterior portion of a lingual wire and a plurality of movable posterior bending units 14 positioned posterior to the anterior plate 12 for receiving or accepting a posterior portion of the lingual wire. The anterior plate 12 is generally arc-shaped to correspond to the anterior portion or arc of the desired lingual archwire and the posterior bending units 14 are positioned to correspond to the posterior portion or arc of the desired posterior portion of the lingual archwire. The number of posterior bending units 14 may vary but preferably at least four are provided.

The anterior plate 12 and posterior bending units 14 are each typically formed from a suitable rigid material such as a metal, metal alloy and the like. The anterior plate 12 is preferably slotted along an arc to accept a lingual wire; however, the skilled artisan will recognize a throughbore is also feasible. As such, the arc-shaped slot along the anterior plate 12 permits shaping of the anterior portion of the lingual wire. In addition, the posterior bending units 14 also accept the lingual wire and thus may also be suitably slotted along a suitable length or width. Thus, slots traversing the posterior bending units 14 permit shaping the posterior portion of the lingual wire. The skilled artisan will appreciate that the slot traversing the anterior plate 12 is generally more arced than slots traversing the bending units 14 since the anterior portion generally corresponds to the patient's incisors and is thus generally more rounded. In some embodiments, the bending units 14 are slotted to accept a lingual wire then clamped in place to further prevent slipping during a bending process. In other embodiments lingual wire is fed or secured through a throughbore that traverses the bending units 14.

Positioning the anterior plate 12 and posterior bending units 14 may be accomplished through the use of one or more housed motors 16. Preferably, the one or more motors 16 selectively actuate each posterior bending unit 14 individually and optionally the anterior plate 12. Movement of each posterior bending unit 14 and anterior plate 12 can be in two directions, three directions, include rotation and the like.

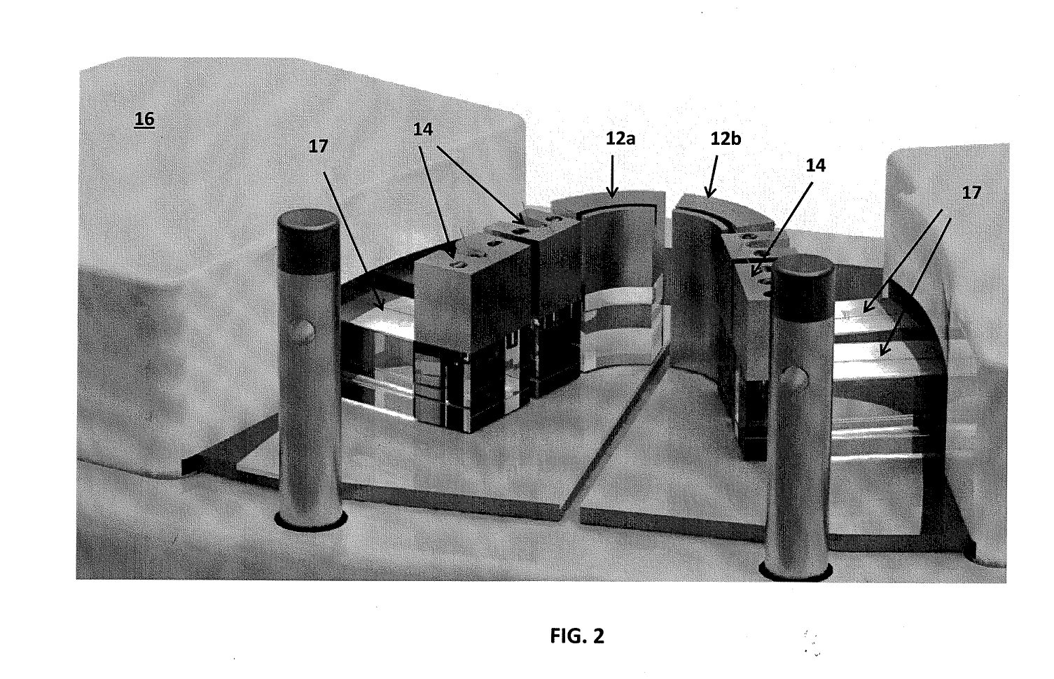

In some embodiments, the anterior plate 12 is not actuated by the motor 16 but is instead fixed in place or adjusted manually; however, in other embodiments the anterior plate 12 is actuated by the motor 16. As can be seen in FIG. 2, in either instance, the anterior plate 12 is preferably configured as at least two halves 12a, 12b correspond to the left and right half of the anterior plate 12. In some embodiments the two halves 12a, 12b are moved towards or apart from one another to decrease or increase a width, which may correspond to a larger size or smaller size. In further embodiments, the two halves 12a, 12b rotate. Providing the anterior plate 12 as two halves 12a, 12b allows further adjustment of position and/or may assist in removing or inserting the lingual wire from slots. In still further embodiments, the anterior plate 12 is removable or interchanged with different sizes, such as a larger adult size or smaller child size. In still further embodiments each half of the anterior plate 12a, 12b is composed of two or more sub-plates which may be independently actuated.

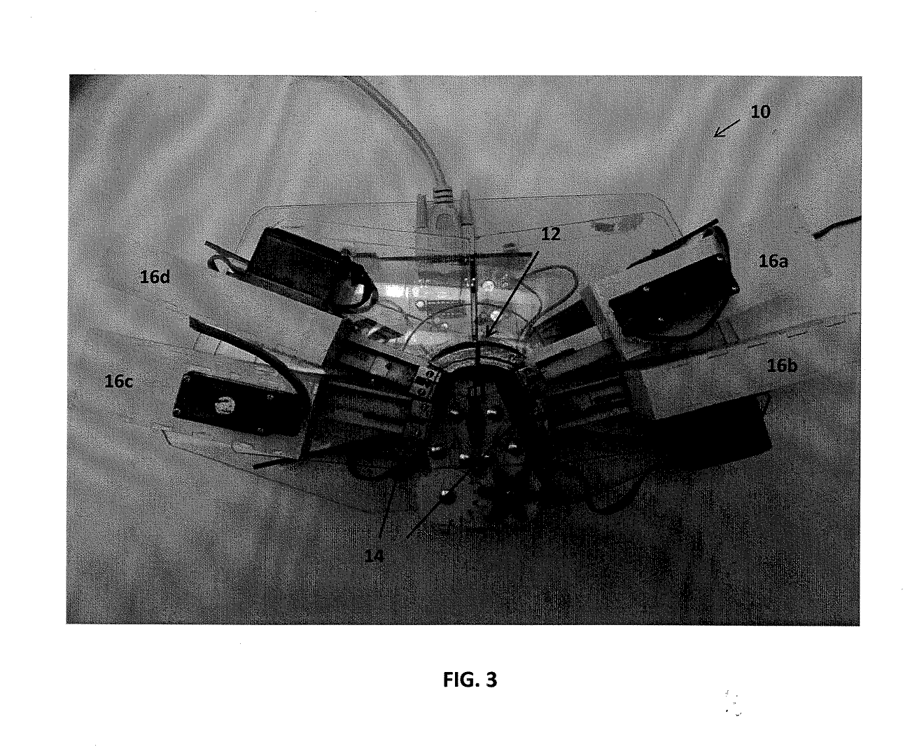

Preferably each of the plurality of bending units 14 is controlled by a motor 16. As can seen in FIG. 3, each of the posterior bending units 14 may be assigned a separate and distinct motor 16a-d. FIG. 2 demonstrates a preferred approach, which is to connect the motor 16 to the posterior bending units 14 via actuating arms 17. By selectively actuating each arm 17, the motor 16 can selectively adjust the inward or outward positioning of each of the posterior bending units 14. The skilled artisan will appreciate that further adjustment of each of the bending units 14 may occur through rotation, either clockwise or counter clockwise, or by upward or downward movement. As such, each of the bending units 14 may be independently adjusted in a single direction, along two directions, or along three directions or more as desired for three dimensional positioning. The skilled artisan will appreciate the motors 16 can be combined into a single motor with at least 4 actuating arms 17 for independent actuation of bending units 14 and the like. During testing, motors 16 having a voltage of about 3.6 volts and an operating at a current of 3.0 amperes were found suitable. Suitable motors were found to produce 21 kg/cm.

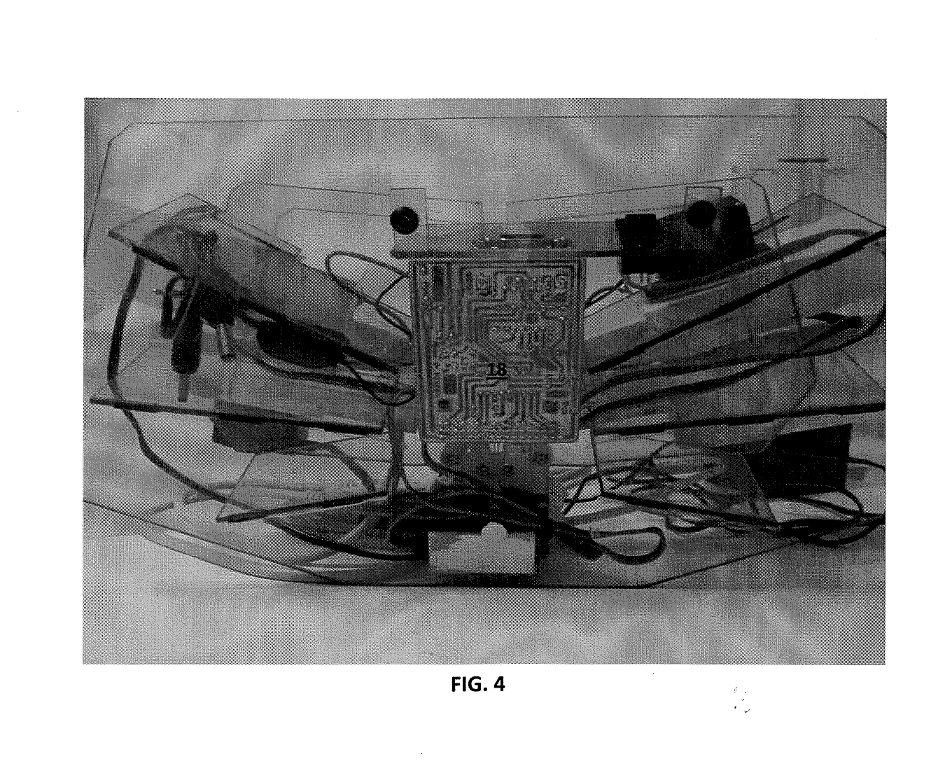

Turning to FIG. 4 the robot provides instruction to the motors 16 through a housed motherboard 18. The motherboard 18 preferably includes any processing components needed for instructing actuation of the motors and any communication interface needed to communicate with an input means. Thus, the motherboard 18 may include any suitable computer processing unit (CPU), integrated circuit (IC) design, microprocessor, random access memory (RAM), read only memory (ROM), and the like as known in the robotic arts. Software or programming may be loaded in memory to translate received communications such as Cartesian coordinates or the like to instructions for movement of the bending units 14 and optionally the anterior plate 12 to form the desired lingual archwire.

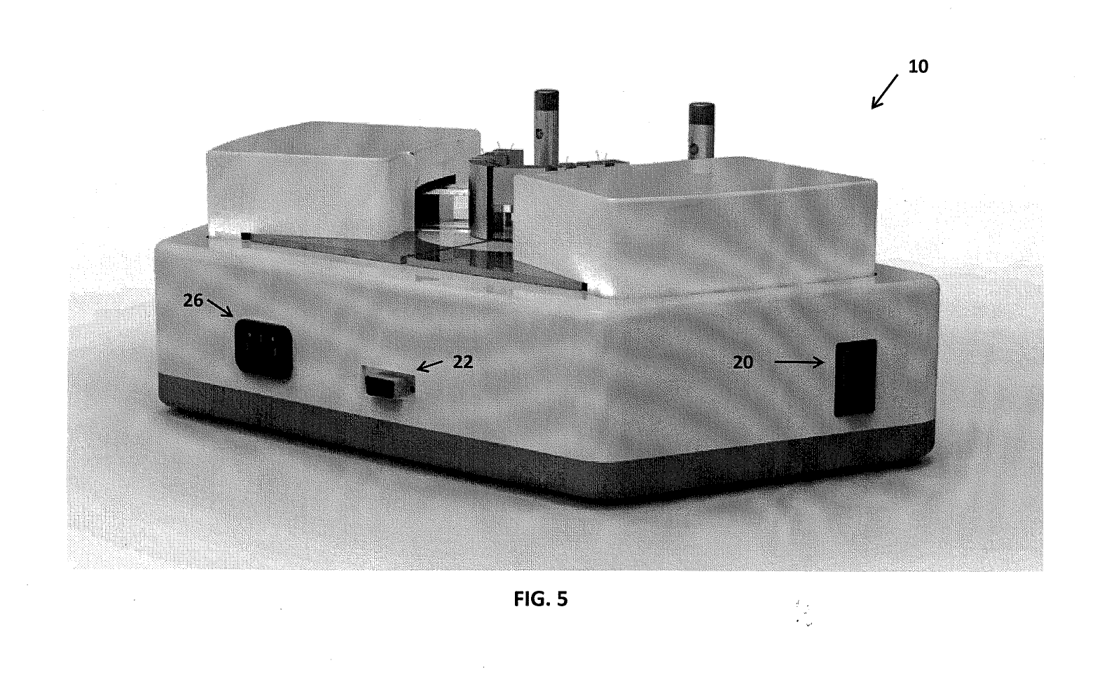

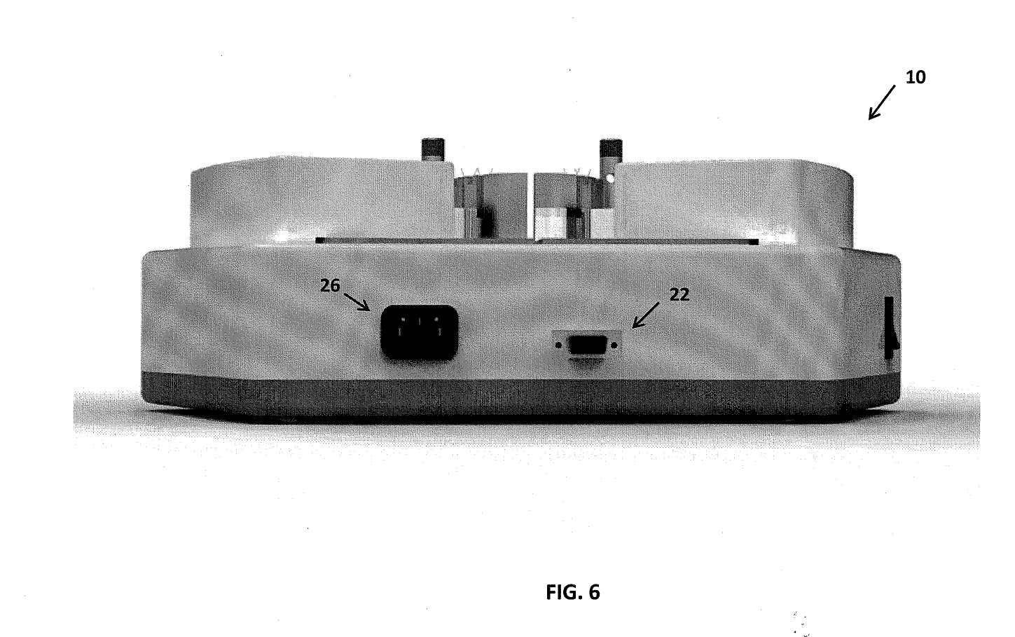

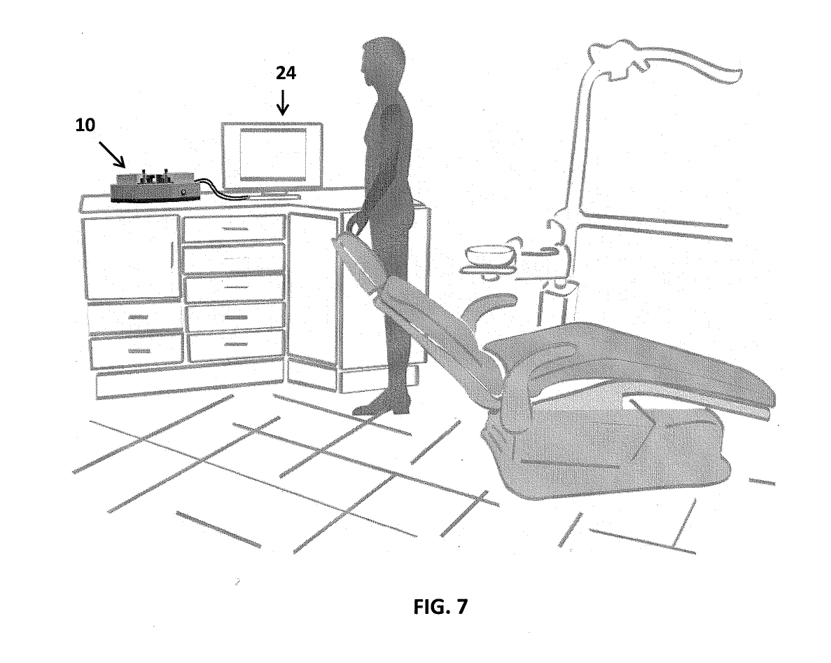

As shown in FIG. 5, a power switch 20 turns on and off power to the robot 10. As shown in more detail in FIGS. 6 and 7 at least one of a variety of connecting ports 22 are present to facilitate connection of the robot 10 to a computer 24 or network and the like. Thus, the robot 10 may also be provided with a suitable driver for connection to the computer 24 or network. The skilled artisan will recognize the computer port 22 may be selected from a variety of connectors and adapters known in the computer arts, such as a USB connector or a variety of pin connectors, either male or female, for direct connection to a computer 24, a RJ45 connector for access to an Ethernet network and the like. Thus, the robot 10 may be connected directly to a computer 24 or may be assigned an internet protocol address (IP address) for connection through a computer network. The skilled artisan will also envision the robot 10 may connect wirelessly to a computer 24 or network through one or more wireless transmitters. The skilled artisan will appreciate the robot 10 may be powered by batteries, may incorporate a power plug 26 as depicted in FIG. 6 and the like as known in the robotic arts.

Preferably, the robot is able to communicate with a computer 24 loaded with LAMBDA software; however, the skilled artisan will appreciate that other software able to assign Cartesian coordinates or to direct the formation of a lingual archwire using the robot 10 may also be used. As introduced above, the robot 10 may connect directly to the computer 24 or may connect via an IP address over a network. In a particularly preferred embodiment, the user loads an image corresponding to the patient's teeth into the computer 24. The image may be a digital photograph or video image, an x-ray image or the like as appropriate. The computer 24 displays the image. Using a computer interface such as a mouse or stylus, the user indicates contact or attachment points for the lingual wire along the patient's depicted dental arch to form a virtual lingual archwire. The computer 24 generates and transfers a corresponding series of coordinates to the robot 10. The robot 10 receives the coordinates or instructions and positions the posterior bending units 14 accordingly. In some embodiments the coordinates refer to Cartisian coordinates and thus the lingual archwire is bent to linearly align and thus linearly connect the coordinates. In some embodiments the coordinates indicate positions along an arc formed by the bent lingual archwire. The skilled artisan will appreciate the computer 24 may be loaded with a driver to for communication with the robot 10. In addition to instructing bending or articulation of lingual wire operations such as grasping or clamping lingual wire, feeding lingual wire, cutting lingual wire and the like can be instructed through the computer 24. Further patient information and the like may be stored in a database as desired.

In a first variation the robot 10 receives the coordinates in the form of Cartesian coordinates and positions the plurality of posterior bending units 14 such that the slot traversing each of the bending units 14 is positioned along the desired arch. Positioning is accomplished via the motors 16. The user then inserts and retains the lingual wire along the anterior plate 12 and posterior bending units 16, such as within corresponding slots. The lingual wire is then held to form the lingual arch. Thus, in this first approach, the anterior plate 12 and posterior bending units 14 act as a template for insertion of the lingual wire to form the desired arch.

In a preferred approach, the lingual wire is loaded into the anterior plate 12 and the posterior bending units 14 prior to final positioning. To assist with loading the lingual wire, the ends of the lingual wire may be aligned with aligning structures 28, which may include throughbores 29, as depicted in FIG. 1. The robot 10 is then instructed to perform the bends according to the Cartesian coordinates or information received from the computer 24 thereby forming a lingual archwire having the desired arch.

In either instance, once the lingual archwire is formed, it is removed from the robot 10 and secured to the lingual surface of the patient's teeth according to a variety of methods known in the orthodontic arts. In further embodiments, the robot 10 may also include a lingual wire feeder, which feeds lingual wire into the posterior bending units 14, anterior plate 12 and the like. The robot 10 may also include a cutting means to cut the formed lingual archwire from the remaining lingual wire.

While the above has been described using a computer 24 loaded with LAMBDA software, the skilled artisan will appreciate that other software may also be used. Such software may accompany the robot 10 in packaging, such as on a compact disc or other computer readable form, as instructions for download and the like. For instance, programs that permit the reproduction of a patient's arch, creation of vector lines between neighboring teeth and calculation of corresponding angles and/or lengths to identify proper positioning of the posterior bending units 14 to form a desired lingual archwire may be used. As an example, the software may present a view of the dental arch on a computer screen and permit the user to selectively identify points corresponding to a desired archwire, such as a series of straight lines to fit the screen image of the dental arch. The computer 24 then calculates the lengths of each of the straight lines and also the angles between each pair of neighboring sections. To calculate these lengths and angles the program can use a pair of Cartesian coordinates (x,y) to each point of the image. The length of the straight line between any two points is then calculated using the Cartesian version of Pythagoras' Theorem. For example, if the points 1 and 2 have the coordinates (x₁,y₁) and (x₂,y₂) respectively, the length of the straight line between them is: l=√(x₂−x₁)²+(y₂−y₁)².

What is claimed is:

1. A robot for the shaping of lingual archwires, comprising:
a) an anterior plate arced according to an anterior portion of a patient's teeth, wherein the anterior plate is capable of accepting an anterior portion of a lingual wire;
b) a plurality of movable posterior bending units positioned posterior to the anterior plate, each bending unit capable of accepting a posterior portion of the lingual wire;
c) a plurality of motors capable of selectively actuating each of the posterior bending units independently along at least one axis to bend the lingual wire along the at least one axis at a plurality of positions;
d) a mother board in electrical communication with the plurality of motors and capable of receiving instructions for desired dimensions of a formed lingual archwire, wherein the motherboard instructs the plurality of motors to selectively actuate the posterior bending units to shape the lingual archwire; and
e) a power source.

2. The robot according to claim 1, wherein the anterior plate is arced complementary to an incisor region.

3. The robot according to claim 1, wherein the anterior plate comprises at least two halves movably mounted to alter an anterior arc of the lingual wire.

4. The robot according to claim 1, wherein the anterior plate is slotted to accept the anterior portion of the lingual archwire.

5. The robot according to claim 1, wherein each of the plurality of posterior bending units are selectively actuated along two axes.

6. The robot according to claim 5, wherein instructions are provided in a Cartesian coordinate system in two dimensions.

7. The robot according to claim 5, wherein each of the plurality of posterior bending units are selectively actuated along three axes.

8. The robot according to claim 7, wherein instructions are provided in a Cartesian coordinate system in three dimensions.

9. The robot according to claim 1, wherein the mother board receives instructions from a computer through a computer port.

10. The robot according to claim 1, wherein the mother board receives instructions from a computer wirelessly.

11. A system for shaping a lingual archwire, comprising:
a) the robot according to claim 1; and
b) a computer operably connected to the robot, wherein the computer comprises software for generating and transferring Cartesian coordinates to the robot for a desired bending of a lingual archwire.

12. A method of shaping a lingual archwire comprising:
a) providing the robot according to claim 1;
b) connecting the robot to a computer loaded with software capable of communicating Cartesian coordinates corresponding to a shaped lingual archwire; and
c) transmitting the Cartesian coordinates to the robot.
